(19) United States
(12) Patent Application Publication
(10) Pub. No.: US 2017/0021516 A1
(43) Pub. Date: Jan. 26, 2017

(54) SEPARATOR FOR PROVIDING SEGMENTS OF COLLATED FASTENERS

(71) Applicant: Enkotec A/S, Skanderborg (DK)

(72) Inventor: Claus Kohler Simonsen, Odder (DK)

(21) Appl. No.: 15/039,662

(22) PCT Filed: Nov. 29, 2013
(86) PCT No.: PCT/DK2013/050403

§ 371 Date: May 26, 2016

(51) Int. Cl. B26D 5/24; F16B 27/00; B26F 3/00; F16B 15/08

(52) U.S. Cl. CPC B26D 5/24; F16B 15/08; F16B 27/00; B26F 3/002

(57) ABSTRACT

The present invention relates to a separator, a separator combined or integrated with a collator and a method of such separators, in order to provide segments of collated fasteners. Segments of collated fasteners are mainly used by builders, who are assembling e.g. wooden structures or for mounting purposes, to engage the fasteners by shooting or screwing the fastener into a structure with a pneumatically operated tool such as a nail gun. The separator is adapted for receiving a continuous flow of collated fasteners, wherein the separator comprises—a fastener counter connected to a controller and configured to send a signal to the controller corresponding to at least one fastener having been counted,—a puncher adapted for punching an end section of at least one fastener to separate a segment including a plurality of collated fasteners in a punching direction, and where the controller is configured to timely activate the puncher, when a predetermined number of collated fasteners in the continuous flow have been counted and a corresponding time for the counting of the predetermined number of collated fasteners has been determined.

### TECHNICAL FIELD

The present invention relates to a separator, a separator combined or integrated with a collator and a method of such separators, in order to provide segments of collated fasteners.

### BACKGROUND

Segments of collated fasteners are mainly used by builders, who are assembling e.g. wooden structures or for mounting purposes, to engage the fasteners by shooting or screwing the fastener into a structure with a pneumatically operated tool such as a nail gun.

Separators for providing the segments are well known. The collation is often done with tapes or by gluing, when the fasteners are received from a fastener fabricating machine. In the known art, a flow of collated fasteners is supplied to a separator having cutting means for cutting over the tape or the glue between two adjacent fasteners.

An example of separation action is displayed in US application 2012/0079702 in FIG. 12, where the cutting means is shown as reference 104.

As the fasteners are supplied from the fabricating machine or machines at a high rate of often more than two thousand fasteners per minute, it is beneficiary when the collator and the separator can work at the same rate in order to have a continuous work flow without bottle necks. This means that the cutting means of the separator must operate at this high rate and precisely perform the cuts between the fasteners. This further means that not only do the cutting means become worn, but they may often also need replacement due to collision with the fasteners. The separator hereby may become a bottle neck.

Hence, a more reliable separator would be advantageous, which may avoid the issues of the known type of the known art.

It is a further object of the present invention to provide an alternative to the known art. Further objectives appear from the description, claims and figures.

### SUMMARY

Thus, the above described object and several other objects are intended to be obtained in a first aspect of the invention by providing a separator for providing segments of collated fasteners, where the separator is adapted for receiving a continuous flow of collated fasteners, wherein the separator comprises
a fastener counter connected to a controller and configured to send a signal to the controller corresponding to at least one fastener having been counted,
a puncher adapted for punching an end section of at least one fastener to separate a segment including a plurality of collated fasteners in a punching direction, and
   where the controller is configured to timely activate the puncher, when a predetermined number of collated fasteners in the continuous flow have been counted and a corresponding time for the counting of the predetermined number of collated fasteners has been determined.

The timely activation of the punching of the end of the fasteners after a predetermined number of collated fasteners has been counted results in a secure separation of a segment of collated fasteners. This is a secure segmentation as no cutting means has to cut the collation tape or glue, whereby any collision between cutting means and the fasteners are avoided. Instead the separation is obtained by the punching, which result in shearing between the last fastener in the segment and the adjacent upstream fastener. The timing of the punching must be precise in order to separate a correct predetermined number of fasteners in the segment. The puncher may punch one or more end of the fasteners for the separation of the segment, which means that the part of the puncher hitting the fastener ends may have larger dimensions and hence be less fragile.

At start-up of the separator, the separator begins receiving the collated fasteners and the counter starts counting the received number of fasteners. To timely activate the puncher the controller has the number of fasteners from the counter to the punching position in order to be able to timely activate the puncher. This means that the counter first counts the number of fasteners that will bring a first fastener to the punching position and then counting the number of fasteners for a complete segment, before the controller activates the puncher.

Another option may be to have a fastener sensor located by the punching position.

After a first segment has been separated, the next activation of the puncher merely relates on counting the predetermined number of fasteners for the next segment, where after the controller activates the puncher and so on.

The separator may comprise opposite and parallel guide rails for arranged for guiding the continuous flow of collated fasteners. This provides a secure guiding of the continuous flow of the collated fasteners by removing a risk of jamming of the fasteners, when a distance between the rails is adjusted to correspond to a size of the collated fasteners including a gap, which is smaller than a fifth to a fourth of the size of the fasteners.

The separator may have the puncher located to provide punching action by end sections of the guide rails. In this way, the guide rails may provide a holding function of the flow of fasteners, when a segment of fasteners is separated by the puncher.

When the fasteners e.g. are collated by tape, the first fastener may have some additional tape sticking out downstream of the fastener. The may be undesired.

Such or like issues may be dealt with by punching a small segment of a few fasteners first, before starting to separate segments with the predetermined number of fasteners.

It is preferred to have an opening at the punching position in the guide rails. The opening may have a size corresponding to six to eight fasteners. Small segments which for any reason are undesired may then exit through the opening, whereas segments containing the predetermined number of fasteners may bridge the opening unaffected.

The puncher may be arranged to pivot so that, when a segment of fasteners has been separated, the puncher is pivoted by pressure from upstream collated fasteners for moving the puncher from a punching position in a direction of movement of and by at a speed at least corresponding to the flow of collated fasteners. It is hereby avoided, that the flow of collated fasteners is obstructed by the puncher.

The separator may also comprise an activator adapted for moving the puncher from a punching position in a direction of movement of and by at a speed at least corresponding to the flow of collated fasteners. Again, it is avoided, that the flow of collated fasteners is obstructed by the puncher.

The separator may comprise an activator or a spring arranged for timely returning the puncher to the punching position. It is hereby ensured that the puncher will be ready for separating a following segment of fasteners.

The counter may comprise a pinion with a diameter and a number of teeth corresponding to fastener to fastener distance, wherein the pinion is engaged with and driven by the collated fasteners. The engagement with the fasteners ensures that all fasteners are counted.

The separator may be configured so that the fasteners each have a longitudinal direction in a vertical plane in the flow of collated fasteners. The segments of fasteners will then be separated also in the vertical plane, which corresponds to the direction of gravity, whereby the segments may be easier handled as the separation may merely result in a drop of the segments.

The separated segments may be accelerated to a speed, which is higher than a speed of the continuous flow of fasteners, by an acceleration unit. The acceleration provides a distance between the segments, which is useful in a later packaging stage, where the segments may be packed in boxes with a predetermined number of segments.

The acceleration unit may comprise, downstream of the collated fasteners being separated into segments, guide rails and a brush-like driving structure for engaging the segments, moving and accelerating the segments. The guide rails may catch the segments and thereby engage the segments. The brush-like driving structure may due to the nature of the brush-like structure compensate for a slight tilt of the segments during separation as the fasteners may slide on or bend the brush-like structure.

The separator may be combined or integrated with a collator, where the collator is arranged for supplying a continuous flow of collated fasteners to the separator. The separator may hereby be combined or integrated with a new or existing collator.

Also, the above described object and several other objects are intended to be obtained in a second aspect of the invention by providing a method of operating a separator for providing segments of collated fasteners, wherein the method comprises
receiving a continuous flow of collated fasteners,
counting the received fasteners with a counter connected to a controller and configured to send a signal to the controller corresponding to at least one fastener having been counted,
timely activation of the puncher by the controller, when a predetermined number of collated fasteners in the continuous flow have been counted and a corresponding time for the counting has been determined,
where the puncher is adapted for punching an end section of at least one fastener to separate a segment including a plurality of collated fasteners in a punching direction, and
   wherein the separator is operated to separate segments of collated fasteners by punching an end section of at least one fastener based on activation of the puncher by the controller.

Moreover, the above described object and several other objects are intended to be obtained in a third aspect of the invention by providing method of operating a separator and collator in combination for providing segments of collated fasteners, wherein the method comprises
collating fasteners with the collator,
providing collated fasteners from the collator to the separator in a continuous flow,
receiving a continuous flow of collated fasteners,
counting the received fasteners with a counter connected to a controller and configured to send a signal to the controller corresponding to at least one fastener having been counted,
timely activating a puncher with the controller, when a predetermined number of collated fasteners in the continuous flow have been counted and a corresponding time for the counting has been determined,
where the puncher is adapted for punching an end section of at least one fastener to separate a segment including a plurality of collated fasteners in a punching direction, and
   wherein the separator is operated to separate segments of collated fasteners by punching an end section of at least one fastener based on activation of the puncher by the controller.

### BRIEF DESCRIPTION OF THE FIGURES

The separator according to the invention will now be described in more detail with regard to the accompanying figures. The figures show one way of implementing the present invention and is not to be construed as being limiting to other possible embodiments falling within the scope of the attached claim set.

FIG. 1 shows a perspective view of a separator in combination with a collator, where the separator comprises an acceleration unit,

FIG. 2 shows an enlarged view of section A of FIG. 1,

FIG. 3 shows a side view of a separator, where a continuous flow of collated fasteners and parts of the separator—here a pinion for counting, guide rails and a puncher,

FIG. 4 shows an enlarged view of section B of FIG. 3,

FIG. 5 shows a side view of a separator, where the puncher has initiated punching action,

FIG. 6 shows an enlarged view of section C of FIG. 5,

FIG. 7 shows a side view of a separator, where the puncher is in punching action and separation of a segment of collated fasteners,

FIG. 8 shows an enlarged view of section D of FIG. 7,

FIG. 9 shows a side view of a separator, where a segment of collated fasteners have been separated, and where the puncher is in a retracted position,

FIG. 10 shows an enlarged view of section E of FIG. 9,

FIG. 11 shows a side view of a separator having an accelerator unit, which is creating a distance between the separated segments,

FIG. 12 shows another type of guide for the collated fasteners,

FIG. 13 shows yet another type of guide.

### DETAILED DESCRIPTION

Collated fasteners may be collated in a number of ways. Also, the fasteners come in a large variety, such as with respect to type and size. This includes:
the collated fasteners are collated with a shank to shank distance
the collated fasteners are collated with overlapping heads
the collated fasteners are fasteners with a D-shaped head
the collated fasteners are nails
the collated fasteners are screws
the collated fasteners are pins
the collated fasteners are clamps
the collated fasteners are two-legged nails
the collated fasteners are two-legged staples
the collated fasteners are a punched-into a substrate type or a rotated-into a substrate type
the fasteners are collated by metal wire
the fasteners are collated with a tape having a polymer which may be heated to stick to the fasteners,
the fasteners are glued together
the fasteners are assembled by lacquer
etc.

The present invention is suitable for separating any of these types of collated fasteners into segments, each having a number of fasteners.

In the Figures and accompanying description supports and frame work are not shown, only parts having a function. This is chosen for reasons of providing improved information and as the skilled person may straight away build adequate supports and frame work. The same applies for electrical wiring and signalling.

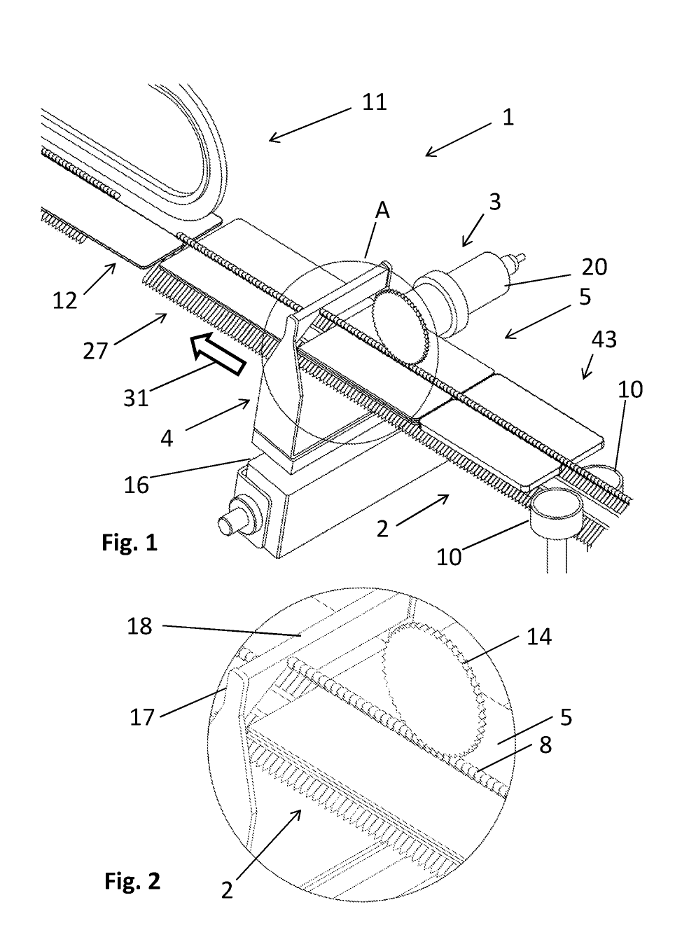

FIGS. 1 and 2 display a separator 1, which receives a continuous flow 2 of collated fasteners 8. In FIG. 1 the continuous flow 2 of fasteners is received from an output side 43 of a not shown collator. The fasteners 8 are driven in a direction by drivers 10 towards the separator 1. The drivers 10 may also by placed at the separator 1. The separator further has a counter 3, a puncher 4 and guide rails 5. Separated segments 27 are conveyed to an accelerator unit 11, which also have guide rails 12. The counter 3 has a pinion 14 engaged with the fasteners 8. The pinion 14 is connected to an encoder 20. The encoder is connected to a non-shown controller. The counter 3 could also be arranged similar to the drivers 10 to be engaged with shanks of the fasteners. A counter may be made in a number of other configurations, such as having an arm arranged for touching passing fasteners and a controller adapted to register every flexing movement of the arm. Or by having a a digital camera providing images of passing fasteners and an image processor adapted to identify and register passing of fasteners and provide signals accordingly to a controller. The puncher 4 is shown in a configuration, where a punching element 18 is connected to a pneumatic actuator 16 via brackets 17. The pneumatic actuator 16 may in another configuration be replaced by an electrical actuator based on electro-magnetic force. Also a linear drive with a servomotor may be used. The puncher 4 is preferably configured to handle a speed of flow of collated fasteners, where the speed is at least 500 fasteners per minute, or 2000 to 3000 fasteners per minute, or more, where the segments 27 may include 30 to 100 collated fasteners. These speeds correspond to state of the art fastener making machines as well as collators. And hence, the separator 1 should work with those speeds, in order not to become a bottle neck in the production line.

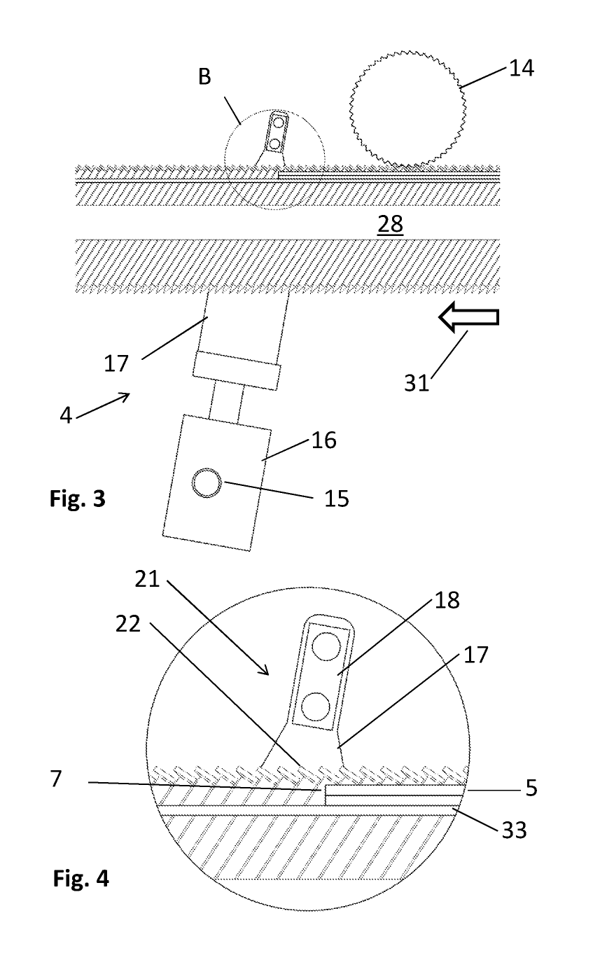

FIGS. 3 to 10 display details of the operation of the separator. The continuous flow of collated fasteners has the direction indicated by the arrow 31. The fasteners are collated by collating tape 28. The counter is engaged with the fasteners by a pinion 14. The puncher 4 has a swivel joint 15, an actuator 16, bracket 17 and a punching element 18. The fasteners are here shown as supported by their heads 22 by upper guide rails 5 and lower guide rails 33.

In FIGS. 3 and 4 the puncher 4 is located in a punching position 21 located at the end section 7 of the upper guide rails 5.

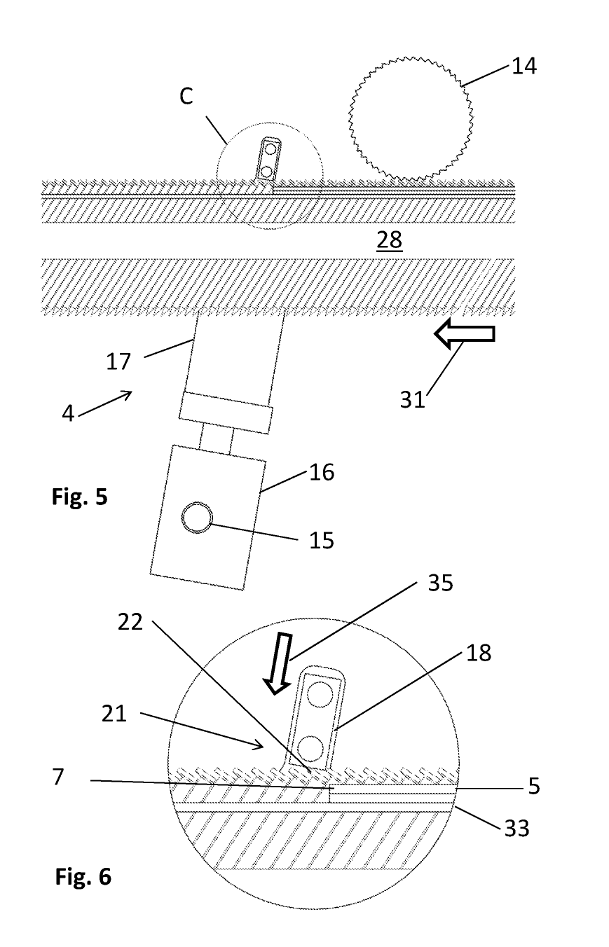

In FIGS. 5 and 6 the puncher has been activated in a direction parallel to the arrow 35 and the punching element 18 hits the fastener head 22.

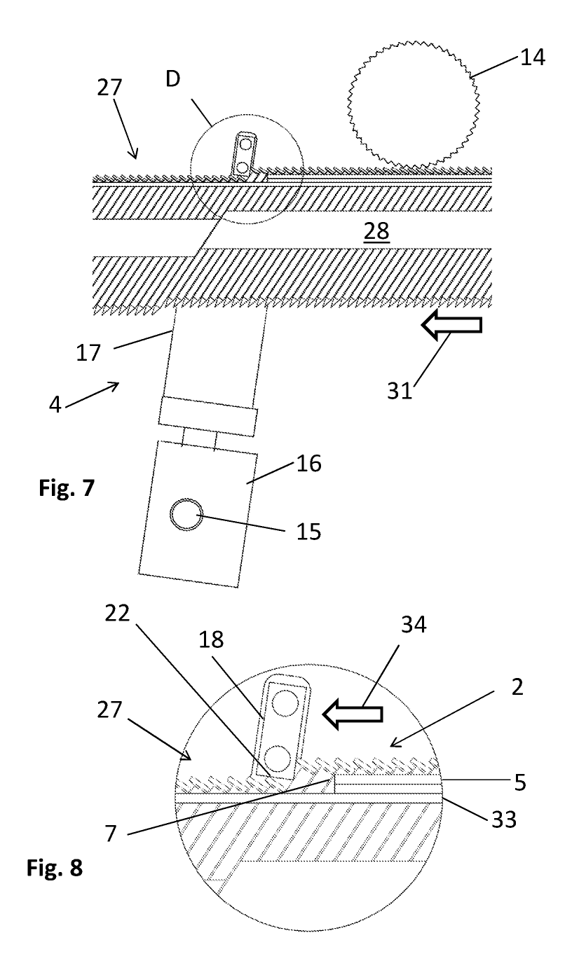

In FIGS. 7 and 8 a segment 27 of collated fasteners has been separated from the flow 2 of fasteners. The segment 27 is now guided by the lower guide rails 33. The upstream arriving fasteners of the flow 2 press the punching element 18 and thereby the puncher in the direction indicated by the arrow 34. The puncher 4 will hereby pivot about the swivel joint 15. Instead of using the press of the flow 2, a non-shown activator may be used. Also, instead of the pivoting motion, the entire puncher 4 may be moved by a non-shown linear actuator.

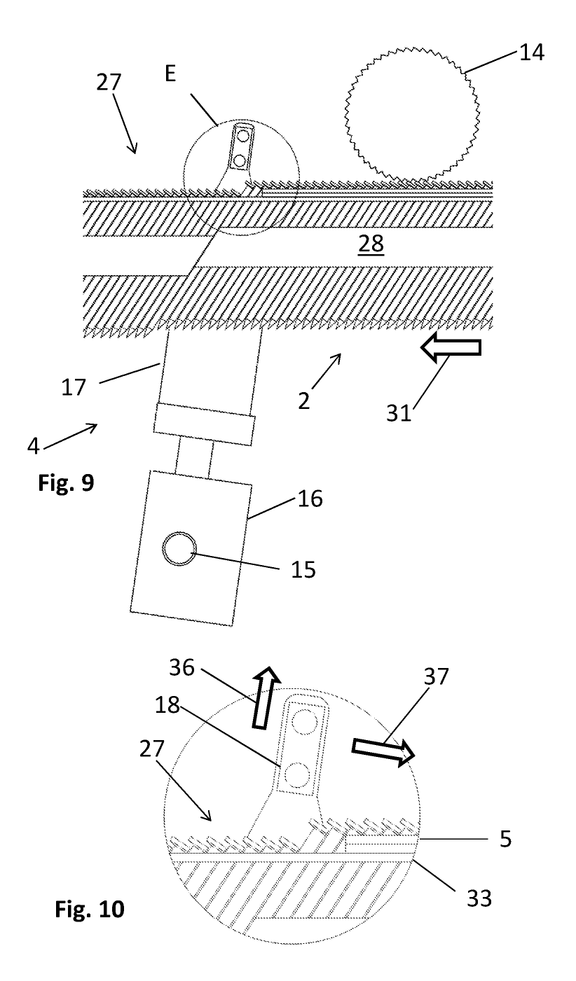

In FIGS. 9 and 10 the segment 27 moves on due to press from the upstream continuous flow 2 of fasteners. In order for the puncher 4 to return to the punching position, the punching element 18 is first retracted upwards as indicated by the arrow 36 and then pivoted back as indicated by the arrow 37. A non-shown spring or actuator may be used for rotating the puncher back. After these events, the puncher will be back in the punching position 21 as shown in FIGS. 4 and 6.

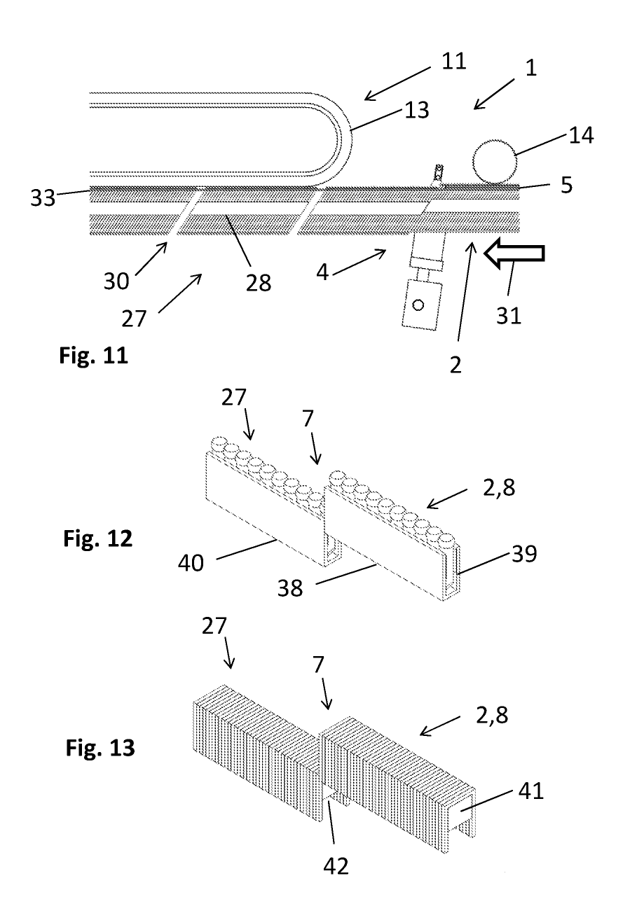

FIG. 11 shows a separator 1 receiving a continuous flow 2 of fasteners in the direction indicated by the arrow 31. A pinion 14 is engaged with the fasteners. A 5 puncher 4 separates segments 27 from the flow 2 by tearing over a collating tape 28. The flow 2 and the segments 27 are guided by upper guide rails 5 and lower guide rails 33, respectively. An acceleration unit 11 having a brush-like driving structure 13 moves and accelerates the segments 27 to obtain a distance 30 between the segments.

FIG. 12 shows a U-shaped upper guide rail 38 and lower guide rail 40 for guiding a flow 2 of fasteners 8. Such guide rails are used, when the fasteners have a no or very small heads, so the fasteners are guided by the inner sides and bottom of the recess 39. Segments 27 are separated by an end section 7 of the upper guide rail 38.

FIG. 13 shows a upper guide rail 41 and lower guide rail 42 for guiding a flow 2 of fasteners 8. The guide rails have a rectangular cross section. Such guide rails may be used, when the fasteners are staples, like in FIG. 13. The staples are guided by the outer sides and top of the rails 41 and 42. Segments 27 are separated by an end section 7 of the upper guide rail 41. Another option would be to guide the staples in U-shaped rails as in FIG. 12.

Although the present invention has been described in connection with the specified embodiments and alternatives, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A separator for providing segments of collated fasteners, wherein the separator is configured to receive a continuous flow of collated fasteners, and wherein the separator comprises:
a fastener counter connected to a controller and configured to send a signal to the controller corresponding to at least one fastener having been counted, and
a puncher adapted for punching an end section of at least one fastener to separate a segment including a plurality of collated fasteners in a punching direction,
wherein the controller is configured to timely activate the puncher, when a predetermined number of collated fasteners in the continuous flow have been counted and a corresponding time for the counting of the predetermined number of collated fasteners has been determined.

2-15. (canceled)

16. The separator according to claim 1, wherein the separator comprises opposite and parallel guide rails arranged for guiding the continuous flow of collated fasteners.

17. The separator according to claim 16, wherein the puncher is located to provide punching action by end sections of the guide rails.

18. The separator according to claim 1, wherein the puncher is arranged to pivot and wherein, when a segment of fasteners has been separated, the puncher is pivoted by pressure from upstream collated fasteners for moving the puncher from a punching position in a direction of movement of and by at a speed at least corresponding to the flow of collated fasteners.

19. The separator according to claim 1, wherein the separator comprises an activator configured to move the puncher from a punching position in a direction of movement of and by at a speed at least corresponding to the flow of collated fasteners.

20. The separator according to claim 18, wherein an activator or a spring is arranged for returning the puncher to the punching position.

21. The separator according to claim 1, wherein the counter comprises a pinion with a diameter and a number of teeth corresponding to the fastener to fastener distance, wherein the pinion is engaged with and driven by the collated fasteners.

22. The separator according to claim 1, wherein the fasteners each have a longitudinal direction in a vertical plane in the flow of collated fasteners.

23. The separator according to claim 1, wherein the separated segments are accelerated to a speed, which is higher than a speed of the continuous flow of fasteners, by an acceleration unit.

24. The separator according to claim 23, wherein the acceleration unit, downstream of the collated fasteners that are separated into segments, comprises guide rails and a brush-like driving structure for engaging the segments, moving and accelerating the segments.

25. The separator according to claim 1, wherein the separator is combined or integrated with a collator, and wherein the collator is arranged for supplying a continuous flow of collated fasteners to the separator.

26. A method of operating a separator for providing segments of collated fasteners, wherein the method comprises:
receiving a continuous flow of collated fasteners,
counting received fasteners with a counter connected to a controller and configured to send a signal to the controller corresponding to at least one fastener having been counted, and
timely activating a puncher by the controller, when a predetermined number of collated fasteners in the continuous flow have been counted and a corresponding time for the counting of the predetermined number of collated fasteners has been determined,
wherein the puncher is configured to punch an end section of at least one fastener to separate a segment including a plurality of collated fasteners in a punching direction, and
wherein the separator is operated to separate segments of collated fasteners by punching an end section of at least one fastener based on activation of the puncher by the controller.

27. A method of operating a separator and collator in combination for providing segments of collated fasteners, wherein the method comprises:
collating fasteners with the collator,
providing collated fasteners from the collator to the separator in a continuous flow,
receiving a continuous flow of collated fasteners,
counting received fasteners with a counter connected to a controller and configured to send a signal to the controller corresponding to at least one fastener having been counted,
timely activating a puncher with the controller, when a predetermined number of collated fasteners in the continuous flow have been counted and a corresponding time for the counting has been determined,
wherein the puncher is configured to punch an end section of at least one fastener to separate a segment including a plurality of collated fasteners in a punching direction, and
wherein the separator is operated to separate segments of collated fasteners by punching an end section of at least one fastener based on activation of the puncher by the controller.

28. The method according to claim 26, wherein the puncher, after a segment has been separated, is moved from a punching position in a direction of movement of and by a speed at least corresponding to the flow of collated fasteners.

29. The method according to claim 28, wherein the puncher after the separation is retracted away from the segment, while the puncher is moved from a punching position in a direction of movement of the flow of collated fasteners.
